(19) United States
(12) Patent Application Publication
(10) Pub. No.: US 2009/0000328 A1
(43) Pub. Date: Jan. 1, 2009

(54) Modular Cooling System and Refrigeration Device for Such a System

(75) Inventors: Thomas Scherer, Hamburg (DE); Matthias Witschke, Hamburg (DE); Ahmet Kayihan Kiryaman, Hamburg (DE)

Correspondence Address: CARTER, DELUCA, FARRELL & SCHMIDT, LLP, 445 BROAD HOLLOW ROAD, SUITE 420, MELVILLE, NY, 11747, US

(73) Assignee: AIRBUS DEUTSCHLAND GMBH, Hamburg (DE)

(21) Appl. No.: 12/158,537

(22) PCT Filed: Dec. 5, 2006
(86) PCT No.: PCT/EP2006/011687

§ 371 Date: Aug. 4, 2008

(30) Foreign Application Priority Data
Dec. 22, 2005 (DE) 10 2005 061 599.6

(51) Int. Cl. F25B 7/00; F25D 3/00; F25B 41/06; B60H 1/32

(52) U.S. Cl. 62/335; 62/529; 62/527; 62/239

(57) ABSTRACT

The invention relates to a cooling system (20) for an aircraft, comprising a number of refrigeration devices (1) which produce refrigeration and transmit this refrigeration to a cooling medium, and a circuit (21), containing at least one refrigeration consumer (22), for the cooling medium, for supplying the refrigeration consumer(s) (22) with refrigeration. Each refrigeration device (1) is a modular unit coupled to the circuit (21) and having a pump (10), which conveys the cooling medium through the circuit (21).

The invention relates to a cooling system for an aircraft and a refrigeration device for such a cooling system.

In the interior of aircraft, a multitude of technical devices is provided which produce heat and which need to be cooled to guarantee a safe mode of operation. Moreover, in the interior of aircraft there are also various enclosed spaces, so-called compartments, which need to be tempered to temperatures below the cabin temperature. Therefore various cooling systems are provided in contemporary aircraft.

From patent specifications DE 43 40 317 C2 and US 2003/0042361 A1, cooling systems are known for cooling food, for example, in an aircraft. In these cooling systems, a central refrigeration device is provided in an aircraft, which conveys cooling medium to individual heat exchanger units via a conduit system. The heat exchanger units are coupled to transport containers to be cooled via additional conduits in the area of storage spaces of an onboard kitchen. These cooling systems require at least one unit to produce the refrigeration and a separate unit for circulating a refrigerating agent liquid through a pipeline system in the aircraft. The circulating unit consists of one or more circulation pumps and an equalising tank.

However, this prior art has the disadvantage that, in addition to the refrigeration units, the refrigerating agent liquid circulating unit, consisting substantially of one or more pumps, has to be installed in the aircraft. To this end, additional installation space has to be provided in the aircraft. Moreover, this prior art provides a single refrigeration conveying unit per refrigeration circuit, which has to be configured for the greatest circulation capacity required.

From patent specification DE 103 61 645 A1, a refrigeration conveying system is known which is divided into two cooling circuits. The circuits are thermally coupled to refrigeration machines, in which the refrigerating medium conducted in the cooling circuits is cooled. Two circulation pumps are respectively provided in the two cooling circuits. In this cooling system, all the refrigeration machines, circulation pumps and reservoirs are combined into a single central unit which takes over the entire supply of the refrigerated transport system with cooled cooling agent.

The object of the invention is to provide a solution which, with a simple construction, enables a high degree of flexibility in respect of installation and adaptation to the existing refrigeration requirement.

This object is achieved by a cooling system with the features of claim 1 and by a refrigeration device according to claim 11. Further preferred configurations of the invention emerge from the dependent claims.

With the present invention, a refrigeration device and a cooling system are created, which enable a spatial decoupling of the production and consumption of the refrigeration. This result is very advantageous because of the large and widely distributed refrigeration requirements in aircraft, in particular in long-haul aircraft.

The cooling system according to the invention has the advantage that, because of its modularity, it can very easily be adapted to the different refrigeration requirements of various cabin configurations. In other words, the number of refrigeration devices can be flexibly selected in order to cover the overall refrigeration requirement of all the refrigeration consumers. This overall refrigeration requirement of the aircraft cooling system is preferably determined on the ground on a hot and humid day. Because of its modularity, the cooling system provides great flexibility with respect to deployment in various aircraft.

The cooling system according to the invention has the further advantage that the refrigeration capacity of the system can be adapted to the current refrigeration requirement in partial-load operation, in that one or more refrigeration devices can be switched on or off.

According to the invention, the cooling system comprises a number of refrigeration devices which produce refrigeration and transfer this refrigeration to a cooling medium, and a circuit for the cooling medium, containing at least one refrigeration consumer, for supplying the refrigeration consumer(s) with refrigeration. Each refrigeration device is a modular unit which is coupled to the circuit and has a pump which conveys the cooling medium through the circuit. The number of modular refrigeration devices is adapted to the refrigeration requirement of the system, wherein the refrigeration devices are connected to the circuit in parallel.

In a preferred embodiment of the invention, this cooling system includes at least two refrigeration devices which are coupled to the circuit to supply the circuit with refrigeration. The at least two refrigeration devices are preferably connected to the circuit in parallel. The refrigeration consumers are likewise also preferably connected to the circuit in parallel.

The cooling medium is typically a liquid and the circuit comprises a conduit system through which the cooling medium can flow. In a preferred embodiment of this cooling system, each refrigeration consumer has an inlet for receiving cooling medium from the circuit and an outlet for discharging cooling medium into the circuit.

According to a preferred configuration of the cooling system according to the invention, the circuit is provided with a bypass device bypassing the refrigeration consumer(s). This enables constant circulation of the cooling medium in the circuit.

The cooling system preferably further includes a reservoir for the cooling medium, which is connected to the circuit, preferably on a return side of the circuit. The reservoir serves to compensate thermal expansion of the cooling medium and provides a reserve in the event of leakage.

In a preferred embodiment of the invention, the cooling system has a second circuit for the cooling medium, containing at least one refrigeration consumer, to supply the refrigeration consumer(s) with refrigeration, wherein the at least one refrigeration device is also coupled to the second circuit. The two circuits are typically hydraulically separate. In this way, one refrigeration device with a compressor can cool several circuits.

According to a further form of the invention a refrigeration device for a cooling system in an aircraft is provided, comprising refrigeration means which produces refrigeration, a device for transferring the refrigeration produced to a cooling medium, wherein the refrigeration device comprises at least one heat exchanger by means of which the cooling medium is brought into thermal contact with the refrigeration produced, and a pump for conveying the cooling medium through the heat exchanger. The refrigeration device is constructed for coupling to a circuit of a cooling system, and the pump for conveying the cooling medium, together with the refrigeration means, forms a modular unit in order to supply the circuit of the cooling system with refrigeration as a modular refrigeration device. The modular refrigeration device is constructed for adaptation to the refrigeration requirement of the system such that it is connected in a multiple to the circuit in parallel.

In a preferred embodiment of the refrigeration device, the refrigeration transfer device has an inlet which conducts the cooling medium to the heat exchanger and an outlet which conducts the cooling medium out of the heat exchanger. The inlet and the outlet of the refrigeration transfer device are constructed for coupling to the circuit and the pump is preferably arranged on the inlet side of the heat exchanger. It is possible, though, for the pump to be arranged on the outlet side of the heat exchanger.

In a preferred embodiment of the refrigeration device, the refrigeration transfer device has a second heat exchanger, by means of which the cooling medium is brought into thermal contact with the refrigeration produced. Correspondingly, the refrigeration transfer device has a second inlet which conducts the cooling medium to the second heat exchanger; and a second outlet which conducts the cooling medium from the second heat exchanger, wherein the second inlet and the second outlet are constructed for coupling to the second circuit. The refrigeration device preferably has a second pump to convey the cooling medium through the second heat exchanger, which is advantageously arranged on the outlet side of the second heat exchanger.

In a preferred embodiment of the refrigeration device, the heat exchanger or the second heat exchanger is part of a refrigerating agent evaporator of the refrigeration device, whereby the refrigeration is transferred to the cooling medium.

Further preferred configurations of the invention emerge from the dependent claims and the following description of embodiments examples, which is carried out with reference to the attached figures, components with identical or similar functions being identified with the same reference symbols.

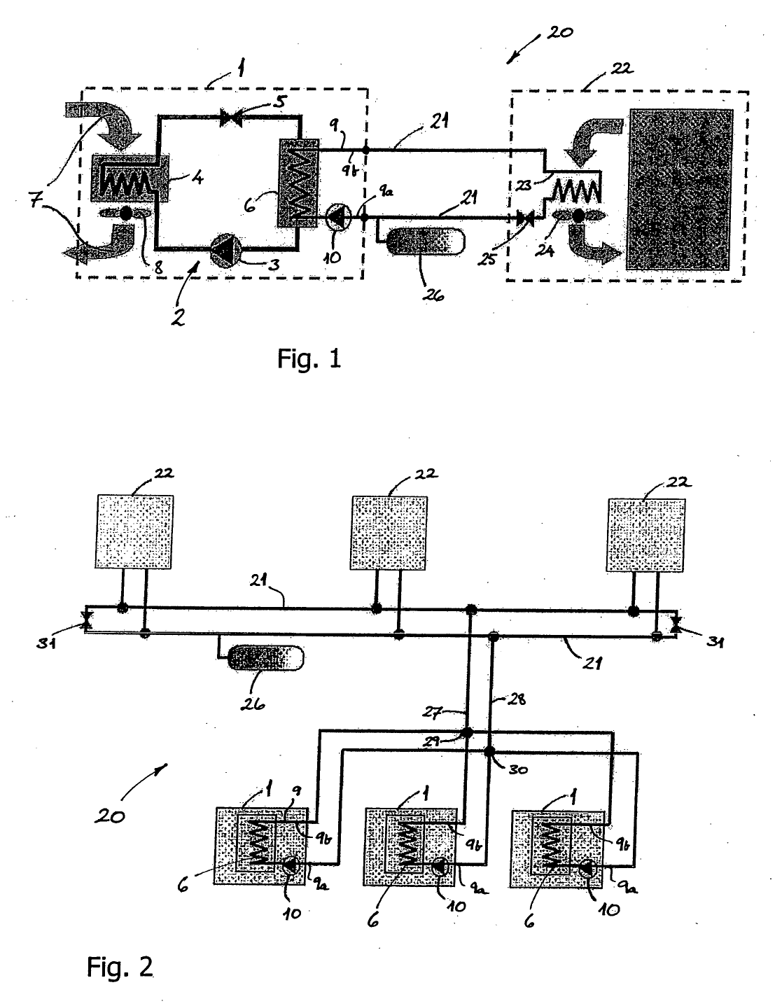

FIG. 1 shows a schematic illustration of a refrigeration device in a cooling system.

FIG. 2 shows a schematic illustration of a cooling system according to one embodiment of the invention.

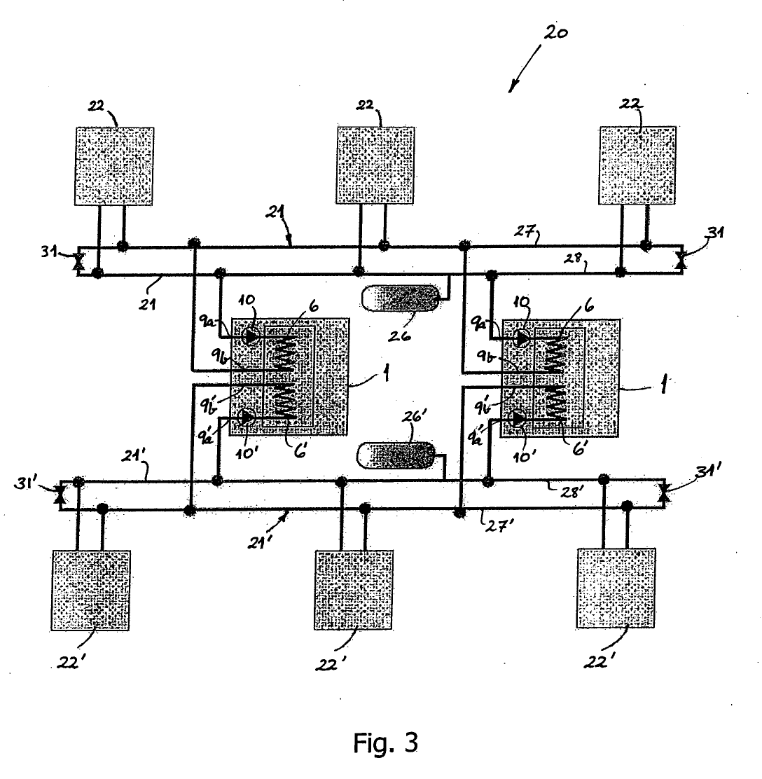

FIG. 3 shows a schematic illustration of a cooling system according to another embodiment of the invention.

FIG. 1 shows a simple embodiment example of a refrigeration device 1, which contains refrigeration means 2 in the form of a conventional compression refrigerating machine. This compression refrigerating machine consists of at least a refrigerating agent compressor 3, a condenser 4, an expansion valve 5 and an evaporator 6. The compression refrigerating machine produces refrigeration in a manner known per se, in that a gaseous refrigerating agent is compressed by the compressor 3 and condensed in the condenser 4. The heat removed from the refrigerating agent in the condenser is given off to a medium 7, such as, e.g. air, which is conveyed through the condenser 4 by means of a fan 8. The condensed liquid refrigerating agent then flows through the expansion valve 5, wherein it expands and thereby undergoes a phase change back into a gas in conjunction with a sharp drop in temperature. The cooled refrigerating agent, again at least partly gaseous, then flows into an evaporator 6, in which the phase change is completed and simultaneously the refrigeration produced is transmitted to a cooling medium.

The evaporator 6 comprises a heat exchanger, by means of which the cooling medium can be brought into thermal contact with the refrigeration produced. The heat exchanger thus functions as a refrigeration transmission device. The heat exchanger or evaporator 6 has a conduit 9 which forms a closed (i.e. hydraulically separate) flow-through route through the evaporator 6 for the cooling medium, in order to transfer as much of the refrigeration produced as possible to the cooling medium. This conduit 9 has an inlet 9a into the refrigeration device which directs the cooling medium to the heat exchanger 6, and an outlet 9b out of the refrigeration device which directs the cooling medium out of the heat exchanger 6. As described below, the inlet 9a and the outlet 9b are constructed for coupling to a circuit. Integrated into the refrigeration device 1 is a pump 10 for conveying the cooling medium through the heat exchanger 6 which is installed on the inlet side of the heat exchanger 6, as shown in FIG. 1.

As can be seen in FIG. 1, the refrigeration device 1 forms part of a modular cooling system 20. The refrigeration device 1 with its integrated pump 10 is coupled via its inlet 9a and its outlet 9b to a circuit 21 of the cooling system 20. The circuit 21, consisting of a conduit system, contains at least one refrigeration consumer 22 and conveys the cooling medium to the refrigeration consumer 22. The “refrigeration consumer” 22 is a general representation of an enclosed space in the interior of an aircraft, which needs to be tempered to a temperature below the cabin temperature, or of a technical device which produces heat and has to be cooled to guarantee a safe mode of operation.

The cooling medium is circulated in the closed circuit 21 in the aircraft by means of the pump 10 integrated into the refrigeration device 1. The refrigeration consumer 22, like all potential refrigeration consumers in the aircraft, uses the cooling medium circulated in the circuit 21 as a heat sink. As shown in FIG. 1, this is implemented, e.g. by a secondary refrigeration conveying system in which by means of a heat-transmitter/fan configuration 23, 24, refrigeration is transmitted from the cooling medium to another medium, preferably air. By means of a valve 25, the refrigeration consumer 22 can continuously or discretely regulate the stream of cooling medium through the heat-transmitter 23 and can thereby adapt the refrigeration capacity gained from the system to its present refrigeration requirement. In other words, if the refrigeration requirement in the refrigeration consumer 22 drops, the valve 25 can be closed in regulated manner, in order to allow less cooling medium into the refrigeration consumer 22. Additionally, the temperature conditions in the refrigeration consumer can be set by regulating the speed of the fan.

The cooling system 20 shown in FIG. 1 further comprises at least one reservoir 26 which, at a suitable place in the aircraft, is preferably connected to the return line of the cooling medium circuit 21. The thermal expansion and leakage of the cooling medium are compensated by the reservoir 26.

As mentioned above, FIG. 1 shows a simple example to illustrate the main principle of the invention, namely the spatial decoupling of the production and the consumption of the refrigeration in an aircraft cooling system. The refrigeration and circulation functions are combined in individual refrigeration devices, which can be multiply employed corresponding to the refrigeration requirement in the aircraft. This becomes clearer from the embodiment example shown in FIG. 2.

FIG. 2 shows an embodiment variant of the cooling system which illustrates the inventive concept more clearly. The cooling system 20 shown in FIG. 2 has three refrigeration devices 1 connected to the circuit 21 in parallel. The circuit 21 again consists of a conduit system with a supply side 27 and a return side 28. On the supply side 27, the outlet 9b of each refrigeration device 1 is connected to a junction 29 and on the return side 28 of the circuit 21 the inlet 9a of each refrigeration device 1 is connected to a junction 30.

In this schematic illustration, it can be clearly seen that each refrigeration device 1 forms a modular unit with an integrated circulation pump 10, which is connected to the conduit system of the circuit 21 in parallel, and that the number of refrigeration devices 1 can be selected in such a way that the aircraft-specific refrigeration requirement is catered for. In the present case, the circuit 21 contains three refrigeration consumers 22, which are again connected to the circuit 21 in parallel. At both ends of the circuit 21 a bypass device 31 is installed bypassing the refrigeration consumers, ensuring constant circulation of the cooling medium in the circuit, even when all the refrigeration consumers 22 close their regulating valves 25 and do not allow any cooling medium through. The circuit 21 can also be constructed without bypass devices 31 if, for example, the regulating valves 25 of the refrigeration consumers cannot completely close, defaulted structurally or by software.

The circulating pumps 10 integrated in the refrigeration devices 1 include non-return valves, whereby the flow of the cooling medium is only permitted in the conveying direction and no return flow takes place if a circulation pump 10 fails. As in the first embodiment example, the conduit system of the circuit 21 has at least one reservoir 26, preferably on the return line 28, which compensates for thermal expansion and leakage of the cooling medium.

In the cooling system illustrated in FIG. 2, the failure of one or two refrigeration devices 1 cannot result in total loss of the refrigeration capacity of the entire system, as long as at least one refrigeration device 1 is still functioning. The refrigeration capacity and the pump capacity of the individual refrigeration devices 1 can be regulated by a central control unit or by local regulators, in order in particular to adapt the refrigeration capacity and/or the pump capacity to the current refrigeration or circulation requirement in part-load operation.

FIG. 3 shows a further embodiment example of an aircraft cooling system 20, in which the refrigeration devices 1 have a modified configuration. Each of the two refrigeration devices 1 has two heat exchangers 6, 6′ for transmitting the refrigeration produced to a cooling medium and is respectively equipped with two circulation pumps 10, 10′, each of which conveys the cooling medium through the associated heat exchangers 6, 6′. The refrigeration devices 1 have conduits 9, 9′ which conduct the cooling medium through the heat exchangers 6, 6′, wherein each of the conduits 9, 9′ provides an inlet 9a, 9a′ into the refrigeration device and an outlet 9b, 9b′ out of the refrigeration device. As in the earlier embodiment examples, the inlets 9a, 9a′ and the outlets 9b, 9b′ are constructed for coupling to a circuit. In this embodiment, the two refrigeration devices 1 are connected to the two separate cooling medium circuits 21, 21′ in parallel.

The two circuits 21, 21′ are hydraulically separate from one another and contain three refrigeration consumers 22 or 22′ in each case. In the cooling system 20 shown in FIG. 3, the failure of one refrigeration device 1 also does not result in complete loss of the refrigeration capacity of the entire system, as long as at least one refrigeration device 1 is still functioning.

The two circuits 21, 21′ again have a reservoir 26, 26′ on the return conduit 28, 28′, with which the thermal expansion and leakage of the cooling medium are compensated. Bypass devices 31, 31′ are likewise installed at both ends of each circuit 21, 21′ to ensure permanent circulation of the refrigerating agent in the circuit.

Among the many advantages of the present invention, great flexibility in respect of installation of the system components and great modularity in respect of adaptation of the installed refrigeration capacity to the refrigeration requirement of different aircraft cabin configurations are particularly worthy of mention. The cooling system provides increased efficiency in part-load operation through the option of switching off one or more refrigeration devices, if they are not needed to cover the momentary refrigeration requirement or the momentary circulation requirement. In this way, the cooling system according to the invention also affords reduced electric power consumption and thus reduced fuel consumption of the aircraft.

1. Modular cooling system for an aircraft, comprising:
a plurality of refrigeration devices which produce refrigeration and transmit this refrigeration to a cooling medium, and
a circuit for the cooling medium, having a plurality of refrigeration consumers, to supply the refrigeration consumers with refrigeration, wherein each refrigeration device coupled to the circuit is a modular unit, having at least one pump which conveys the cooling medium through the circuit, wherein the number of modular refrigeration devices is adapted to the refrigeration requirement of the system, and wherein the refrigeration devices are connected to the circuit in parallel.

2. Modular cooling system according to claim 1, wherein the modular cooling system includes at least two refrigeration devices connected to the circuit in parallel for supplying the circuit with cooling medium.

3. Modular cooling system according to claim 1, wherein the refrigeration consumers are connected to the circuit in parallel.

4. Modular cooling system according to claim 1, wherein the circuit comprises a conduit system, wherein each refrigeration consumer has an inlet for receiving cooling medium from the circuit and an outlet for discharging cooling medium into the circuit.

5. Modular cooling system according to claim 1, wherein the circuit is provided with a bypass device bypassing the refrigeration consumer(s).

6. Modular cooling system according claim 1, wherein it includes a reservoir for the cooling medium connected to the circuit on a return side of the circuit.

7. Modular cooling system according to claim 6, wherein the reservoir is not part of one of the modular refrigeration devices.

8. Modular cooling system according to claim 1, wherein the cooling system includes a second circuit for a cooling medium hydraulically separate from the first circuit and contains at least one refrigeration consumer, for supplying the refrigeration consumer(s) with refrigeration, and in that the modular refrigeration devices are also connected to the second circuit in parallel.

9. Modular cooling system according to claim 1, wherein at least one control unit is provided for regulating the cooling system such that one or more refrigeration devices are switched on or off in dependence upon the refrigeration requirement of the system.

10. Modular cooling system according to claim 1, wherein at least one control unit is provided for regulating the cooling system such that one or more of the pumps are switched on or off in dependence upon the circulation requirement of the system.

11. Modular refrigeration device for a cooling system in an aircraft, comprising:
refrigeration means,
a device for transmitting refrigeration produced to a cooling medium, the refrigeration transmission device comprising at least one heat exchanger, by means of which the cooling medium is brought into thermal contact with the refrigeration produced, and
a pump for conveying the cooling medium through the heat exchanger, wherein the refrigeration device is constructed for coupling to a circuit of a cooling system having a plurality of refrigeration consumers, wherein the pump for conveying the cooling medium forms a modular unit together with the refrigeration means in order to supply the circuit of the cooling system with refrigeration as a modular refrigeration device, wherein the modular refrigeration device is constructed for adaptation to the refrigeration requirement of the system such that a plurality thereof is connected to the circuit in parallel.

12. Modular refrigeration device according to claim 11, wherein the refrigeration transmission device has an inlet which conducts the cooling medium to the heat exchanger, and an outlet which conducts the cooling medium out of the heat exchanger, and wherein the inlet and the outlet are constructed for coupling to the circuit.

13. Modular refrigeration device according to claim 11, wherein the pump is arranged on the inlet side of the heat exchanger.

14. Modular refrigeration device according to claim 11, wherein the refrigeration transmission device has a second heat exchanger, by means of which the cooling medium is brought into thermal contact with the refrigeration produced, a second inlet which conducts the cooling medium to the second heat exchanger, and a second outlet which conducts the cooling medium out of the second heat exchanger, wherein the second inlet and the second outlet are constructed for coupling to the second circuit.

15. Modular refrigeration device according to claim 14, wherein a second pump is provided for conveying the cooling medium through the second heat exchanger.

16. Modular refrigeration device according to claim 15, wherein the second pump is arranged on the inlet side of the second heat exchanger.

17. Modular refrigeration device according to claim 11, wherein the heat exchanger or the second heat exchanger is part of a refrigerating agent evaporator of the refrigeration means.
